(19) United States
(12) Patent Application Publication
(10) Pub. No.: US 2014/0165152 A1
(43) Pub. Date: Jun. 12, 2014

(54) WHITEBOARD RECORDS ACCESSIBILITY

(71) Applicant: MICROSOFT CORPORATION, Redmond, WA (US)

(72) Inventor: Karim Farouki, Seattle, WA (US)

(73) Assignee: Microsoft Corporation, Redmond, WA (US)

(21) Appl. No.: 13/711,320

(22) Filed: Dec. 11, 2012

(51) Int. Cl. H04L 29/06

(52) U.S. Cl. CPC H04L 63/08
USPC 726/4

(57) ABSTRACT

Technologies are generally described for providing whiteboard records accessibility to users interacting with a whiteboard. A whiteboard may enable two or more users to interact with the whiteboard concurrently. The whiteboard may identify the users interacting with the whiteboard and may identify permission settings associated with the users. Based on the identification of the users and detected permission settings, the whiteboard may activate a whiteboard records accessibility mode to provide access to whiteboard records. In a public mode, any user may interact with the whiteboard, and the whiteboard may provide access to a public records data store. In a private mode, the whiteboard may provide access to a separate private records data store associated with an authenticated user interacting with the whiteboard. When two users interact with the whiteboard concurrently, the whiteboard may separate the whiteboard records such that each user can access records corresponding to the detected permission settings.

### BACKGROUND

With the proliferation of collaborative computing and networking technologies, the need to share content and to control and interact with shared is prevalent. Teleconferencing and desktop sharing are example techniques for enabling users in remote locations to share content and to interact with each other without being in the physical presence of each other. Additionally, the ability to continuously share content, interact with and update content has become useful as users collaborate on projects and desire to generate and update content in real-time. Interactive whiteboards are often used to capture written content on a display screen and enable real-time content manipulation, and are often used in public settings to enable multiple users to interact with the whiteboard concurrently. Conventional interactive whiteboards may not have the capabilities of enabling a user access and interact with private records over a public whiteboard.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to providing whiteboard records accessibility to users interacting with a whiteboard. A whiteboard application or service may identify one or more users interacting with the whiteboard and may identify permission settings associated with the users. The whiteboard may activate a whiteboard records accessibility mode to provide access to whiteboard records. In a public mode, any user may interact with the whiteboard, and the whiteboard may provide access to a public records data store. In a private mode, the whiteboard may provide access to private whiteboard records associated with a user interacting with whiteboard. When two users interact with the whiteboard concurrently, the whiteboard may separate the whiteboard records such that each user can access records corresponding to the detected permission settings.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF DRAWINGS

FIG. 1 illustrates an example collaborative environment where whiteboard sharing may be employed;

FIG. 2 illustrates example whiteboard records accessibility modes;

FIG. 3 illustrates example user authentication techniques;

FIG. 4 illustrates example forking and content distinguishing on a whiteboard;

FIG. 5 is a networked environment, where a system according to embodiments may be implemented;

FIG. 6 is a block diagram of an example computing operating environment, where embodiments may be implemented; and

FIG. 7 illustrates a logic flow diagram for a process of enabling whiteboard records access, according to embodiments.

### DETAILED DESCRIPTION

As briefly described above, technologies are generally described for providing whiteboard records accessibility to users interacting with a whiteboard. A whiteboard may enable multiple users to interact with the whiteboard independently and concurrently. The whiteboard may identify a user interacting with the whiteboard and may identify permission settings associated with the user. Based on the identification of the user, the whiteboard may activate a whiteboard records accessibility mode to provide access to whiteboard records. The whiteboard may initially activate a public mode, such that any user may interact with the whiteboard, and may have access to a publicly accessible records data store. Upon authentication of a user, the whiteboard may activate a private mode to provide access to a separate private records data store associated with the user. When two users interact with the whiteboard concurrently, the whiteboard may separate the whiteboard records such that each user can access records corresponding to the detected permission setting.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in the limiting sense, and the scope of the present invention is defined by the appended claims and their equivalents. While the embodiments will be described in the general context of program modules that execute in conjunction with an application program that runs on an operating system on a personal computer, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable hardware. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable storage medium can for example be implemented via one or more of a volatile computer memory, a non-volatile memory, a hard drive, a flash drive, a floppy disk, or a compact disk, and comparable media.

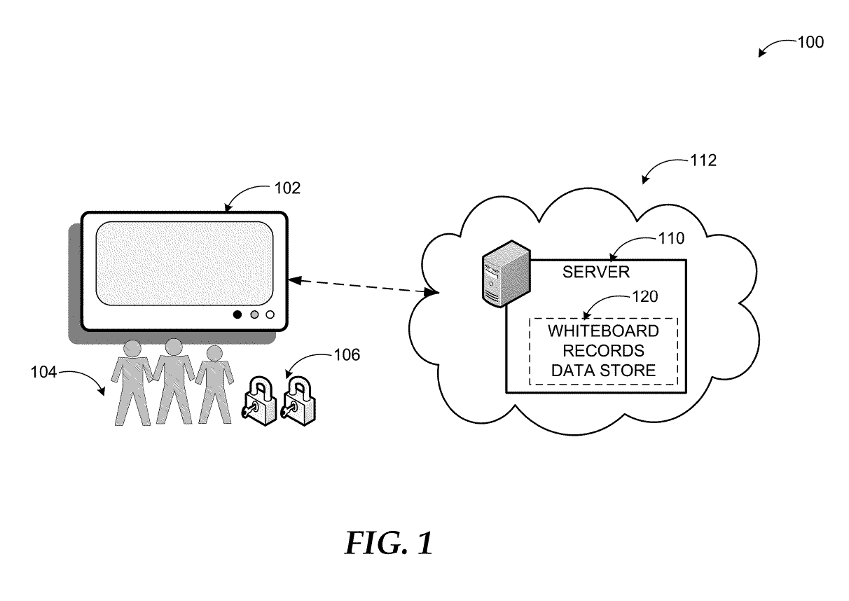

FIG. 1 illustrates an example collaborative environment where whiteboard sharing may be employed. In a collaborative environment two or more users may be an interactive whiteboard 102, and may enable one or more users 104 to interact with the whiteboard concurrently. The whiteboard 102 may be configured to receive input from multiple users 104, and may also be configured to recognize handwriting and translate handwriting into text, enable quick annotations on content displayed on the whiteboard, and receive input from multiple input devices and computing devices.

In an example embodiment, the interactive whiteboard 102 may be connected with a server 110 over a network 112 such as a cloud network, which may be a wired or wireless network. Data and content records 120 associated with the whiteboard 102 may be stored in a data store on the server 110, and may be provided to the whiteboard 102 over the network 112. When a user initially interacts with the whiteboard 102, the whiteboard 102 may detect the interaction by detecting an action on the whiteboard, such as, for example, an input action on the interface, such as a selection, a navigation action, a resizing action, a formatting action, newly generated content, and edits to existing content displayed on the whiteboard. When the whiteboard 102 detects the interaction, the whiteboard may provide content and records 120 from the whiteboard records data store, and when the whiteboard 102 receives input from the one or more users 104, the input content may be stored in the whiteboard records 120 data store associated with the whiteboard 102. The whiteboard records may be provided to the one or more users 104 over the whiteboard based on predefined accessibility and permission settings 106, such that content provided over the whiteboard is dependent on the identification and permission settings of the user interacting with the whiteboard.

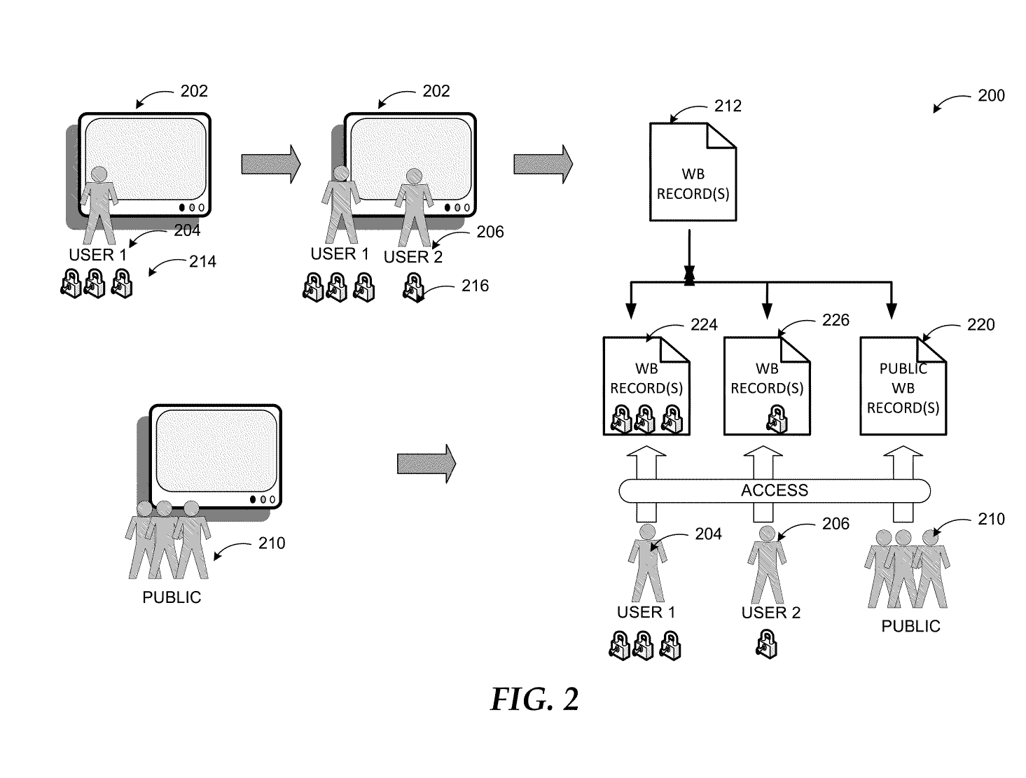

FIG. 2 illustrates example whiteboard records accessibility modes, according to some example embodiments. As illustrated in diagram 200, in a collaborative environment, a whiteboard 202 may enable multiple users 204, 206 to interact with the whiteboard 202 concurrently such that the each user can input content on the whiteboard, and can interact with software, applications, and web browsers on the whiteboard 202. In an example embodiment, the whiteboard 202 may be configured to enable various accessibility modes, such as public and private modes, such that certain content and records are accessible to certain users over the whiteboard depending on the mode. For example, in a public mode, any user 210 may interact with the whiteboard, and the content and records that are accessible to the user in the public mode may be provided from a public whiteboard records stored 220 stored in a publicly accessible data store. Publicly accessible records may include content that is not associated with a specific user, and may not include any sensitive, private or secured content. The public mode may be a default mode such that an initial interaction with the whiteboard 202 by any user 210 activates the whiteboard 202 in the public mode. When a user interacts with the whiteboard 202 in a public mode, the whiteboard 202 may enable general accessibility to the public whiteboard records 220. Private information associated with one or more users may not be accessed in the public mode such that personal and private information is maintained private and secure.

In a private mode, a user 204 may interact with private and personal content associated with the user 204. The private mode may be initiated by a user log-in or via authentication of the user by the whiteboard. For example, the user 204 may provide credentials such as a log-in name and a password, or similar user specific credentials for activating the whiteboard 202 in the private mode. The user's 204 personal and private content and interactions may be saved as private whiteboard records 224 associated with the user 204. The private whiteboard records 224 may be stored in a private records data store associated with the user 204, so that when the user 204 interacts with the whiteboard 202 in the private mode, the user can access the user's private records, and may edit, update, and provide additional content on the whiteboard. The updated and new content may be stored in the private whiteboard records 224 associated with the user 204. Additionally, when activated in a private mode, the whiteboard 202 may be automatically “wiped” and restored to a public mode after a predefined period of inactivity and/or a log-out by the user, in order to limit the access by other users to the user's 204 private whiteboard records 224.

In some embodiments, a whiteboard configured in a private mode may enable activation of a guest mode, such that a guest user may log in to the private whiteboard and a may be granted limited access to whiteboard records. The guest mode may be similar to a public mode such that private and personal records of the private users are protected, and the guest user may be prevented from accessing and/or modifying private whiteboard records.

Additionally, a user may control who can access and modify the user's personal whiteboard records. The user may designate whether content provided by the user is private or public so that the designated content is saved in the appropriate whiteboard records data store. For example, the user 204 may input content on the whiteboard 202 and save the content to the whiteboard records data store associated with the user 204. The user's content may be initially saved in the user's private whiteboard records data store, and the user 204 may be the only one with access to the content. The user 204 may designate other users who may have access to the content, and additionally the user 204 may designate that the content is public, causing the content to be stored in the publicly accessible records 220 data store.

If the user 204 desires to share the content with the user 204 may give access to another user 206 by designating that the other user 206 may access the content. The user's private whiteboard records 224 may be accessible to the designated other user 206 from whiteboard records 226 associated with the other user 206. Additionally, the user 204 may select an access level for each other user 206 that the user 204 shares the private whiteboard records 224 with. For example, the user 204 may enable a read only access and/or an editing access for a specific other user 206 and also for the public.

In another example embodiment, the whiteboard 202 may recognize permission levels 214, 216 for users, such that the content and records that are available to a user interacting with the whiteboard may be provided based on a detected permission level of the user and user authentication. For example, the user 204 may desire to interact with the whiteboard 202 in a private mode. The user 204 may provide authentication, such as a password or log on credentials in order to activate a private mode on the whiteboard 202. When the whiteboard 202 authenticates the user 204, the private whiteboard records 224 associated with the user 204 may be accessible over the whiteboard 202. Additionally, other whiteboard records 212 may also be accessible to the user 204 based on the permission level 214 of the user. For example, some records may be designated read-only based on a certain permission level, while other records may enable editing based on a detected permission level. In an example scenario, parental or administrative records may be available based on detection of a parental or administrative permission level. In another example, a whiteboard may be used in an academic setting. A professor or teacher may have full access to teacher appropriate whiteboard records, while a student may have more restricted permissions and may have access to a more limited student appropriate whiteboard records.

In another example embodiment, two or more users 204, 206 may interact with the whiteboard concurrently. If the two or more users 204, 206 interacting with the whiteboard have different permission levels 214, 216, the whiteboard 202 may enable access to the more restricted of the detected permission levels. For example, if the first user 204 has an administrative access permission level 214 and the second user 206 has a more restrictive permission level 216, the level of access to records may be provided based on the other user's 206 more restrictive permission level 216, such that only whiteboard records deemed accessible based on the other user's 206 permission level 216 are accessible while both users 204, 206 interact with the whiteboard. Additionally, while multiple users are concurrently logged-in and interacting with the whiteboard 202, each user's private whiteboard records may not be accessible to the other users interacting with the whiteboard.

Further, when two or more users having different permission levels interact with the whiteboard 202 concurrently, the whiteboard records may be forked or separated such that users with more restrictive permission levels can only access whiteboard records with corresponding permission levels. Similarly, if data is imported onto the whiteboard 202 from the whiteboard records, where the permission level for the imported data is less restrictive than other users concurrently interacting with and/or viewing the whiteboard, the whiteboard records may be forked such that a user with a less restrictive permission level can access everything including the private data associated with the user, and another user with a more restrictive permission level can only access non-private or public whiteboard records 220.

Additionally, the whiteboard 202 may enable a presenter mode where the whiteboard 202 may recognize viewer permission levels and presenter permission levels. For example, viewers of a whiteboard, such as users present in the room when the whiteboard is being used by a presenter, may be given limited, or public access to the whiteboard records, while the presenter, who actively interacts with the whiteboard, may have full presenter access to whiteboard records.

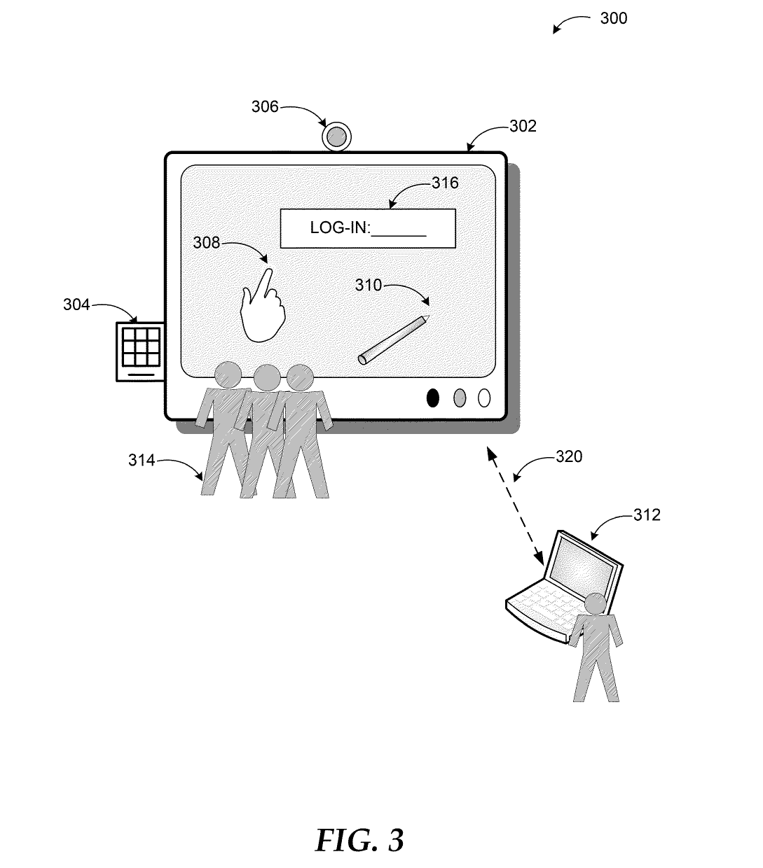

FIG. 3 illustrates example user authentication techniques, according to some embodiments. As demonstrated in diagram 300, an interactive whiteboard 302 may enable two or more users 314 to interact with the whiteboard 302 concurrently. In some examples, the users 314 may interact with the whiteboard 302 directly using an input device. Some example conventional input devices may be an interactive stylus 310, electronic pen, keyboard, and/or mouse. Additionally, the interactive whiteboard 302 may be a touch or gesture-enabled device, such that hand gestures and finger touch 308 may be recognized as input methods for interacting with, controlling, and providing content to the whiteboard 302. Further, two or more users may interact with and provide input to the whiteboard employing a client devices, such as a tablet, personal computer, smartphone or other input device which may be connected with the whiteboard 302 via a wired or wireless connection 320.

As previously discussed, the whiteboard 302 may be configured to recognize permission levels and to enable a private mode based on user authentication. The whiteboard 302 may employ several techniques to identify a user interacting with the whiteboard 302 and to authenticate the user. For example, a private mode may be initiated by a user log-in or via authentication of the user by the whiteboard. Some example identification and authentication techniques may include scanning a badge, QR code, or other scanning code employing a reader 304, facial and body or gesture recognition employing a video device 306, finger and hand 308 recognition, input device (stylus 310) recognition including direct input devices such as a stylus or pen and indirect input devices such as a client device 312 connected to the whiteboard 302 over a wired or wireless connection 320. Further, a user may be authenticated by a manual log-in 316 on the whiteboard 302 providing a username and password. Additionally, the whiteboard 302 may be configured to identify a user and authenticate the user by presence detection employing a motion sensing input device. Based on the identification and authentication of the user, the whiteboard 302 may activate a whiteboard records accessibility mode, such as a private or public mode, and may enable the appropriate whiteboard access settings for the users. When two or more users interact with the whiteboard concurrently, the whiteboard may provide the access to the two or more users concurrently based on the most restrictive permission settings detected with each user.

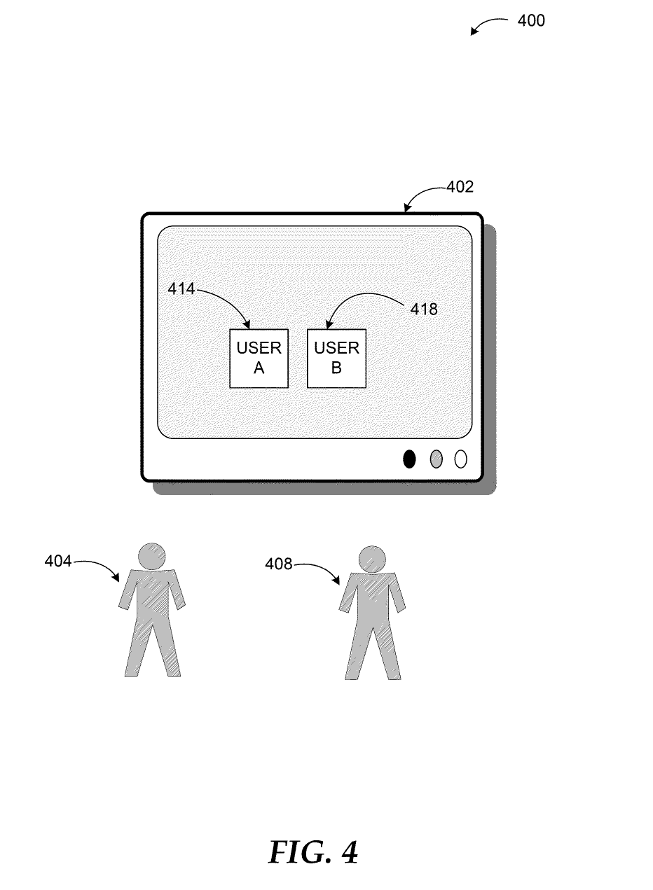

FIG. 4 illustrates example forking and content distinguishing on a whiteboard, according to some embodiments. As demonstrated in diagram 400, the whiteboard 402 may enable two or more users 404, 408 to interact with the whiteboard 402 concurrently. As previously discussed, the whiteboard 402 may be configured to identify each user interacting with the whiteboard 402 based on the type of input and other identification techniques. In an example embodiment, the whiteboard 402 may distinguish input from each user, such that when displaying content from each user on the whiteboard 402, the whiteboard 402 may indicate which user provided the input for the displayed content.

In an example scenario, the whiteboard 402 may receive input from the two or more users 404, 408 concurrently. When the whiteboard receives input from two or more users, the whiteboard 402 may recognize, track, and distinguish content that is input from each user over the network such that the content displayed on the interactive whiteboard 402 may reflect which user provided the content. For example, a first user 404 may input content directly at the interactive whiteboard 402 employing a stylus and/or touch input. The interactive whiteboard 402 may display the content 414 from the first user 404, and may indicate that the content was provided by the first user. An indication may be a text label and/or a graphical representation such as color coding for indicating that the content 414 was input by the first user 404. Likewise, a second user 408 may provide input to the whiteboard 402 employing the second user's input method or device. When the whiteboard 402 receives the content input from the second user 408, the whiteboard 402 may display the content 418 from the second user 408 on the interface of the whiteboard 402, and may indicate that the content 418 was provided by the second user 408 by providing a textual and/or graphical indication. Example indications may be color and/or graphical indications, annotations, and/or pop-up textual panes and comments specifying which user provided the displayed content. Additionally the whiteboard 402 may adjust placement, formatting, and style of the content to distinguish content from each user.

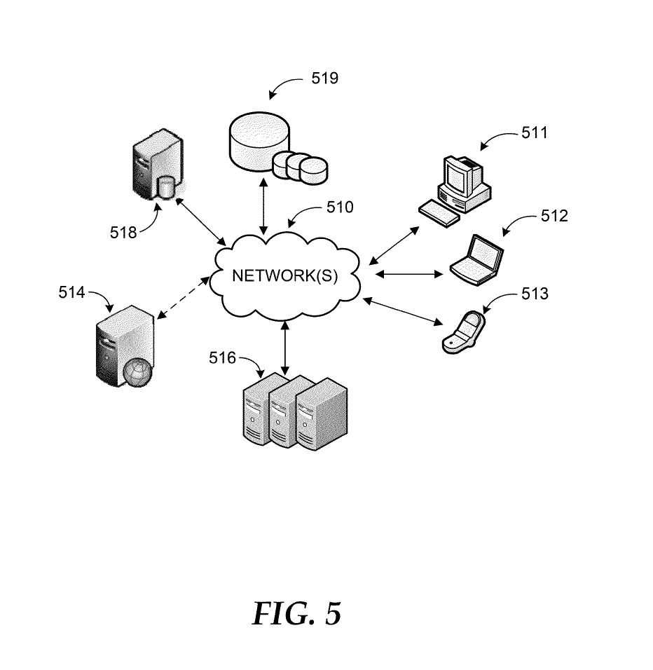

FIG. 5 is an example networked environment, where embodiments may be implemented. In addition to locally installed applications, such as application 622 discussed below, whiteboard user management may also be employed in conjunction with hosted applications and services that may be implemented via software executed over one or more servers 506 or individual server 508. A hosted service or application may be a web-based service or application, a cloud based service or application, and similar ones, and communicate with client applications on individual computing devices such as a handheld computer 501, a desktop computer 502, a laptop computer 503, a smart phone 504, a tablet computer (or slate), 506 (‘client devices’) through network(s) 510 and control a user interface presented to users. One example of a web-based service may be a productivity suite that provides word processing, spreadsheet, communication, scheduling, presentation, and similar applications to clients through a browser interface on client devices. Such a service may enable users to interact with a whiteboard, and may enable the whiteboard to operate in private and public modes, providing access to appropriate whiteboard record by users as discussed herein.

Client devices 501-506 are used to access the functionality provided by the hosted service or application. One or more of the servers 506 or server 508 may be used to provide a variety of services as discussed above. Relevant data may be stored in one or more data stores (e.g. data store 514), which may be managed by any one of the servers 506 or by database server 512.

Network(s) 510 may comprise any topology of servers, clients, Internet service providers, and communication media. A system according to embodiments may have a static or dynamic topology. Network(s) 510 may include a secure network such as an enterprise network, an unsecure network such as a wireless open network, or the Internet. Network(s) 510 may also coordinate communication over other networks such as PSTN or cellular networks. Network(s) 510 provides communication between the nodes described herein. By way of example, and not limitation, network(s) 510 may include wireless media such as acoustic, RF, infrared and other wireless media.

Many other configurations of computing devices, applications, data sources, and data distribution systems may be employed to provide interactive whiteboard sharing. Furthermore, the networked environments discussed in FIG. 5 are for illustration purposes only. Embodiments are not limited to the example applications, modules, or processes.

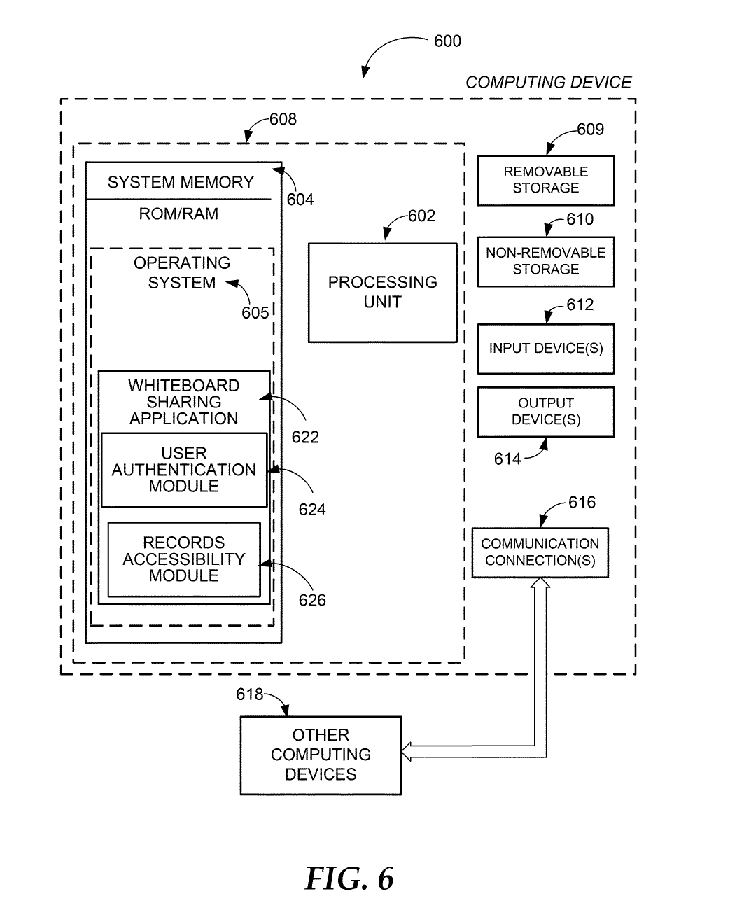

FIG. 6 and the associated discussion are intended to provide a brief, general description of a suitable computing environment in which embodiments may be implemented. With reference to FIG. 6, a block diagram of an example computing operating environment for an application according to embodiments is illustrated, such as computing device 600. In a basic configuration, computing device 600 may be any touch and/or gesture enabled device in stationary, mobile, or other form such as the example devices discussed in conjunction with FIGS. 1-4, and include at least one processing unit 602 and system memory 604. Computing device 600 may also include a plurality of processing units that cooperate in executing programs. Depending on the exact configuration and type of computing device, the system memory 604 may be volatile (such as RAM), non-volatile (such as ROM, flash memory, etc.) or some combination of the two. System memory 604 typically includes an operating system 605 suitable for controlling the operation of the platform, such as the WINDOWS®, WINDOWS MOBILE®, or WINDOWS PHONE® operating systems from MICROSOFT CORPORATION of Redmond, Wash. The system memory 604 may also include one or more software applications such as program modules 606, whiteboard access application 622, and user authentication module 624 and records accessibility module 626.

User authentication module 624 may operate in conjunction with the operating system 605 or whiteboard access application 622 to enable identification and authentication of one or more users interacting with a whiteboard as discussed previously. Records accessibility module 626 may enable a whiteboard records accessibility mode based on the user identification, authentication, and permission settings detection. This basic configuration is illustrated in FIG. 6 by those components within dashed line 608.

Computing device 600 may have additional features or functionality. For example, the computing device 600 may also include additional data storage devices (removable and/or non-removable) such as, for example, magnetic disks, optical disks, or tape. Such additional storage is illustrated in FIG. 6 by removable storage 609 and non-removable storage 610. Computer readable storage media may include volatile and nonvolatile, removable and non-removable media implemented in any method or technology for storage of information, such as computer readable instructions, data structures, program modules, or other data. System memory 604, removable storage 609 and non-removable storage 610 are all examples of computer readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 600. Any such computer readable storage media may be part of computing device 600. Computing device 600 may also have input device(s) 612 such as keyboard, mouse, pen, voice input device, touch input device, an optical capture device for detecting gestures, and comparable input devices. Output device(s) 614 such as a display, speakers, printer, and other types of output devices may also be included. These devices are well known in the art and need not be discussed at length here.

Computing device 600 may also contain communication connections 616 that allow the device to communicate with other devices 618, such as over a wireless network in a distributed computing environment, a satellite link, a cellular link, and comparable mechanisms. Other devices 618 may include computer device(s) that execute communication applications, other directory or policy servers, and comparable devices. Communication connection(s) 616 is one example of communication media. Communication media can include therein computer readable instructions, data structures, program modules, or other data in a modulated data signal, such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media.

Example embodiments also include methods. These methods can be implemented in any number of ways, including the structures described in this document. One such way is by machine operations, of devices of the type described in this document.

Another optional way is for one or more of the individual operations of the methods to be performed in conjunction with one or more human operators performing some. These human operators need not be collocated with each other, but each can be only with a machine that performs a portion of the program.

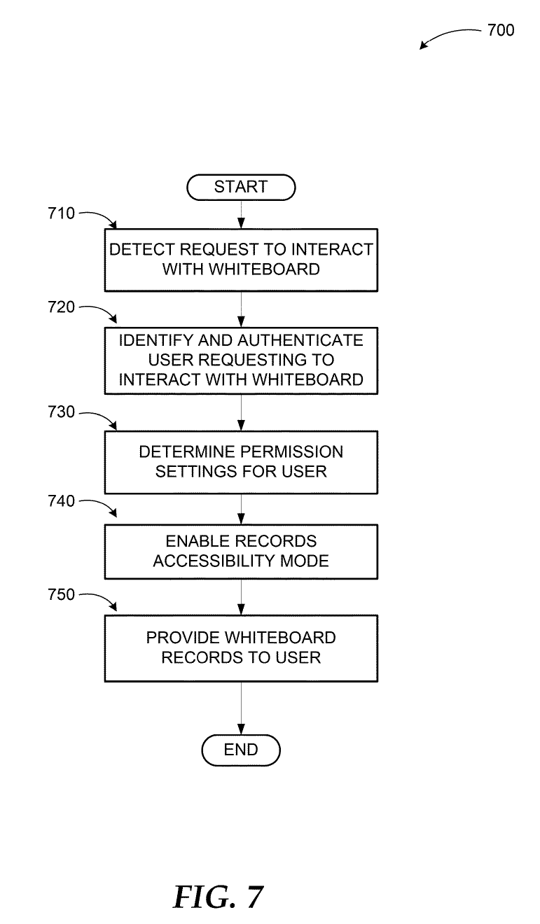

FIG. 7 illustrates a logic flow diagram for a process of enabling whiteboard records accessibility, according to some example embodiments. Process 700 may be implemented as part of an application or an operating system.

Process 700 begins with operation 710, where an interactive whiteboard may detect a request to interact with a whiteboard by one or more users. Upon detection of a request to interact with the whiteboard, at operation 720 the whiteboard may identify and authenticate the one or more users requesting to interact with the whiteboard. The whiteboard may identify and authenticate the one or more users based on a variety of identification techniques, including, but not limited to, input device recognition, facial and body recognition, finger and/or hand recognition, presence and motion detection, badge and/or QR code scanning, manual log-in credentials. At operation 730, based on the identification and authentication of the one or more users interacting with the whiteboard, the whiteboard may determine permission settings for the user. Some users may be public users, and the whiteboard may determine that the user has public permission settings. If a user is a private user, the whiteboard may determine permission settings for the user such as what type of whiteboard records the user may access. Additionally, a private user may have access to whiteboard records previously associated with the private user.

At operation 740, the whiteboard may enable a whiteboard records accessibility mode, such as a public mode, a private mode, and/or an administrator mode based on the determined permission settings. In a public mode, any user may access publicly available whiteboard records. In a private mode, a user may access personal and private whiteboard records associated with the user. Additionally, in the private mode, a private user may access certain types of records based on predefined permission settings. For example, an administrator may have access to administrator records, and in another example, an adult, parent or teacher may have access whiteboard records which may not be accessible to a student or a minor.

Operation 740 may be followed by operation 750, where the appropriate whiteboard records are provided to the user at the whiteboard. In the public mode, the whiteboard records may be stored and provided by a public whiteboards record data store. In a private mode, the whiteboard records may be stored in and provided by a private whiteboard record data store associated with each private user. Additionally, when two or more users interact with the whiteboard concurrently, the whiteboard may determine access and permission settings for each of the concurrent users and may enable access based on the more restricted of the detected permission levels. Further, the whiteboard may separate the whiteboard records such that users with more restrictive permission levels may have more limited access to records with corresponding permission levels and a user with a higher permission level may be able to access more records including the private data associated with the user.

The operations included in process 700 are for illustration purposes. Enabling whiteboard records accessibility modes and user management according to embodiments may be implemented by similar processes with fewer or additional steps, as well as in different order of operations using the principles described herein.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. A method executed at least in part in a computing device for enabling whiteboard records accessibility, the method comprising:
detecting a request to interact with a whiteboard;
identifying and authenticating a requesting user;
determining one or more permission level settings associated with the user;
activating a records accessibility mode;
providing access to whiteboard records through the whiteboard to the user based on the one or more permission level settings associated with the user; and
in response to the whiteboard receiving an input from the user, recognizing, tracking, and distinguishing content that is input such that the content displayed on the whiteboard indicates that the user provided the content.

2. The method of claim 1, wherein detecting a request to interact with the whiteboard further comprises:
detecting one or more of: an input action, newly generated content, and an edit to existing content displayed on the whiteboard.

3. The method of claim 1, further comprising:
identifying and authenticating the user employing one or more of: a facial recognition, a body recognition, a presence recognition, a motion sensing recognition, a finger recognition, a hand recognition, a gesture recognition, an input device recognition, scanning a badge with a reader, scanning a QR code with a QR reader, and a manual log-in.

4. The method of claim 1, further comprising:
activating one or more of: a public mode and a private mode based on the authentication of the user and the determined permission level settings.

5. The method of claim 4, further comprising:
activating the public mode upon detection of an initial interaction with the whiteboard.

6. The method of claim 5, further comprising:
when the whiteboard is activated in the public mode, providing whiteboard records from a public records data store.

7. The method of claim 4, further comprising:
activating the private mode upon authentication of the user.

8. The method of claim 7, further comprising:
when the whiteboard is activated in the private mode, providing whiteboard records from a private records data store associated with the authenticated user.

9. The method of claim 8, further comprising:
providing records from the private records data store corresponding to the detected permission level settings.

10. The method of claim 9, wherein the detected permission level settings include one or more of: administrative, read-only, and edit access.

11. The method of claim 1, further comprising:
enabling two or more users to interact with the whiteboard concurrently.

12. The method of claim 11, further comprising:
detecting permission level settings for each of the two or more users interacting with the whiteboard; and
providing whiteboard records to the two or more users concurrently based on a most restrictive detected permission level setting.

13. The method of claim 11, further comprising:
detecting permission level settings for each of the two or more users interacting with the whiteboard; and
separating the whiteboard records on the whiteboard such that each user has access to the whiteboard records corresponding to each user's detected permission level setting.

14. A computing device for enabling whiteboard records accessibility, the computing device comprising:
a memory storing instructions;
a processor coupled to the memory, the processor executing a whiteboard access application, wherein the whiteboard access application is configured to:
detect a request to interact with a whiteboard;
identify and authenticate a requesting user;
determine permission level settings associated with the user;
activate a records accessibility mode;
provide access to whiteboard records through one or more of the whiteboard and a networked computing device in communication with the whiteboard to the user based on the one or more permission level settings associated with the user;
divide the whiteboard records based on the one or more permission level settings associated with the user, wherein if the user has a less restrictive permission level, the user is provided access to private data associated with the user in a private mode, and if the user has a more restrictive permission level, the user is provided access to public whiteboard records in a public mode; and
if the user is provided access to the whiteboard records in the private mode, automatically restore the whiteboard records to the public mode after a predefined period of inactivity and/or a log-out by the user.

15. The computing device of claim 14, wherein the records accessibility mode includes one or more of: the private mode and the public mode, and wherein the public mode is automatically activated upon detection of an initial interaction with the whiteboard, and the private mode is activated based on the authentication of the user and the determined permission level settings.

16. The computing device of claim 14, wherein the records accessibility mode includes a presenter mode.

17. The computing device of claim 16, wherein a presenting user is provided whiteboard records from a private whiteboard records store associated with the presenting user and a viewing user is provided whiteboard records from a public whiteboard records store when the whiteboard is activated in the presenter mode.

18. A computer-readable memory device with instructions stored thereon for enabling whiteboard records accessibility, the instructions containing:
detecting a request to interact with a whiteboard;
identifying and authenticating a requesting user;
determining permission level settings associated with the user;
activating a records accessibility mode including one or more of: a public mode and a private mode;
providing access to whiteboard records through one or more of the whiteboard and a networked computing device in communication with the whiteboard to the user based on the one or more permission level settings associated with the user;
in response to the whiteboard receiving input from the user, recognizing, tracking, and distinguishing content that is input such that the content displayed on the whiteboard indicates that the user provided the content;
allowing the user to designate the permission level settings required for the content saved to whiteboard records; and
if the user is provided access to the whiteboard records in the private mode, automatically restoring the whiteboard records to the public mode after a predefined period of inactivity and/or a log-out by the user.

19. The computer-readable memory device of claim 18, further comprising:
when the whiteboard is activated in the public mode, providing whiteboard records from a public records data store; and
when the whiteboard is activated in the private mode, providing whiteboard records corresponding to the determined permission level setting of the user from a private records data store associated with the authenticated user.

20. The computer-readable memory device of claim 19, wherein the instructions further comprise:
enabling the user to share private whiteboard records associated with the user with one or more other users; and
storing the user's private whiteboard records in a whiteboard records data store associated with the one or more other users.
